(19) United States
(12) Patent Application Publication
(10) Pub. No.: US 2006/0008396 A1
(43) Pub. Date: Jan. 12, 2006

(54) Exhaust gas post treatment arrangement

(76) Inventors: Stephan Wursthorn, Stuttgart (DE); Andreas Genssle, Musberg (DE); Norbert Breuer, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/531,278

(22) PCT Filed: Jun. 24, 2003
(86) PCT No.: PCT/DE03/02100

§ 371 Date: Apr. 13, 2005

(30) Foreign Application Priority Data
Oct. 15, 2002 (DE) 102 47 946.1

(51) Int. Cl. B01D 53/34

(52) U.S. Cl. 422/180; 422/171; 422/177

(57) ABSTRACT

An exhaust treatment apparatus having a body through which the exhaust of an internal combustion engine can flow, which body has regions with different flow resistances; the body has flow regions that are separate from one another and are each delimited by a delimiting device and each have at least one inflow opening that the exhaust can act on; the different flow resistances in the regions are produced by differently embodied delimiting devices.

### PRIOR ART

The invention is based on an exhaust treatment apparatus as generically defined by the preamble to the independent claim.

A filter for cleaning exhaust gases is already known from DE 3538107 A1, in which the material has different porosity along a flow line.

Furthermore, ceramic honeycomb filter units are already known from DE 3529684. These are based on the wall flow filter principle. The particles entrained by the exhaust are separated out at the edges by channels in a ceramic matrix that are closed at the ends and through which the exhaust gas flows axially. The charged exhaust here passes through the ceramic substrate in accordance with the flow pressure ratios inside the channel and the thickness of the filter cake on the ceramic substrate. The substrate can be catalytically coated, which permits an oxidation of soot even at lower temperatures. After a certain operating duration, the pressure loss at the passage through such a filter increases significantly due to the buildup of filtrate. The regeneration of the separated soot on the ceramic substrate then takes place by means of oxidation with the residual oxygen in the exhaust or through the addition of an oxidation agent, e.g. ozone or nitrogen dioxide. This can cause the combustion of the soot on the filter to vary from region to region. The critical issue here is primarily those operating states in which a residual quantity of soot collects in the downstream region, i.e. at the end oriented away from the inflow region. Due to the higher filter cake density, the overall flow resistance via the filter cake and substrate is greater than in the upstream region. The flow then passes through upstream filter region due to its preferable flow. The heat released by the chemical conversion of the soot in the downstream filter region can no longer be sufficiently dissipated. A local overheating occurs, leading to very high temperatures particularly in the downstream filter region. As a result, powerful thermal gradients can build up in the ceramic matrix, which can cause thermal stresses and even substrate fractures. Another negative effect can be the thermal destruction of the effective catalytic coating on the wall flow filter, which significantly impairs its function.

### ADVANTAGES OF THE INVENTION

The apparatus according to the present invention, with the characterizing features of the independent claim, has the advantage over the prior art of producing a filter or a catalytic converter, which, during the regeneration, generates a flow guidance that reduces the danger of the development of a zone with a lower through flow and therefore an increased temperature buildup. If the apparatus is embodied in the form of a particle filter, then during the loading of the filter, an initial difference in the permeability is partially compensated for by the increase in the filter cake, which is more intense in regions of higher through flow. Furthermore, different objectives can be advantageously pursued by intentionally varying the permeability of the delimiting devices to produce different gradients in the flow resistance.

Advantageous modifications and improvements of the apparatus disclosed in the independent claim are possible by means of the measures taken in the dependent claims.

It is particularly advantageous to adjust the permeability of the delimiting devices and/or the flow resistance of the flow regions through an appropriate choice of the thickness of the delimiting devices in the flow direction of the exhaust gas. This variation can easily be provided both in the direction of the incoming gases and in the radial direction; in the latter case, different flow channels have different permeabilities and different flow resistances depending on their position on a substrate.

It is particularly advantageous to radially vary the permeability in order to achieve an improved flow distribution or an improved utilization of the catalytic converter and/or of the filter volume over the cross section of a filter or catalytic converter. With a comparatively low degree of complexity, this measure advantageously prevents a potential burning-through of the filter in the outer region, i.e. in the edge region of the filter, and provides for a better utilization of the volume. It is therefore also possible to use less expensive filter substrates that have a comparatively low heat resistance (e.g. cordierite in comparison to silicon carbide).

Other advantages ensue from the characteristics described in the dependent claims and the specification.

### DRAWINGS

Exemplary embodiments of the invention are shown in the drawings and will be explained in greater detail in the subsequent description.

FIG. 1 shows a filter with flow regions whose flow resistance decreases in the flow direction,

FIG. 2 shows an exemplary embodiment whose flow resistance increases in the flow direction of the exhaust,

FIG. 3 shows a honeycomb filter made of ceramic, with a radial variation of the flow resistance,

FIG. 4 is a cross-sectional side view of a reservoir catalytic converter, and

FIG. 5 shows another exemplary embodiment of the present invention.

### DESCRIPTION OF THE EXEMPLARY EMBODIMENTS

FIG. 1 shows a partial region 10 of a permeable body comprised of silicon carbide ceramic or cordierite. The part labeled with the reference numeral 1 denotes the incoming exhaust flowing into a flow region 4 shown by way of example, which is embodied in the form of a filter chamber. At the end oriented away from the inflow opening 7, the filter chamber 4 is delimited by a closure 9 embodied in the form of a closing wall. The flow region, which is embodied as square in cross section, is laterally delimited on each of its 4 sides by a delimiting device embodied in the form of a filter wall 2. On the side oriented toward the filter chamber 4, the filter walls 2 are each covered with a ceramic coating 12 whose thickness decreases from the inflow opening 7 toward the closed region 9. The exhaust can pass through the filter walls 2 (i.e. the walls are permeable) so that on the other side of the filter walls 2, the exhaust can once again exit the filter body as depicted in the sectional view (see the arrows labeled with the reference numeral 5 that indicate the outgoing exhaust). The region of the filter chamber 4 oriented toward the inflow opening 7 here represents a first region with a first flow resistance to the passage of exhaust through the filter wall and the region of the filter chamber 4 oriented toward the closed region 9 represents a second region 13 with a flow resistance that is less than the flow resistance of the region 11. The exhaust-permeable filter body here is composed of a multitude of filter chambers 4 that extend parallel to the filter chamber shown in the drawing and adjoin directly above and below the region shown in FIG. 1.

The exhaust flows through a filter body in an intrinsically known manner, in the process of which soot can be deposited on the filter walls while the exhaust penetrates the permeable filter walls 2 and exits the permeable filter body again on the other side of the filter walls that delimit the respective flow region. The additional coating 12 further improves the flow through the filter because the flow resistance decreases in the flow direction of the exhaust. As a result, the downstream region of the filter in the vicinity of the closed regions 9 has a better flow. This plays a role primarily in the regeneration of a particle filter because when there is poor flow through the downstream region, the dissipation of heat is no longer assured so that thermal stresses occur that could lead to damage to the filter. The coating 12 on the filter walls 2 here has been applied to the ceramic substrate that constitutes the filter walls 2. The overall flow resistance is consequently comprised of the wall resistance of the substrate and the flow resistance of the additionally applied coating 12. The variation of the coating thickness can be adjusted through a correspondingly selected coating process.

In an alternative embodiment form, the coating 12 can be a washcoat that also contains catalytically active components. This layer of washcoat with a suspension of aluminum oxide particles on the carrier medium can increase the effective surface area significantly, for example by up to three orders of magnitude. This coating can contain noble metals, for example platinum and palladium or mixtures of these components. The coating can also contain ceroxide, which encourages oxygen storage. In a simplified embodiment form, the washcoat or the coating 12 is only applied in the region close to the inflow opening of the flow regions or filter chambers 4, while the last centimeter, for example, of the ceramic monolith remains uncoated. In addition to an immersion technique with a correspondingly reduced immersion depth for the washcoat layer, a preceding masking technique can also be used. In another alternative embodiment form, in lieu of applying the coating 12, the thickness of the wall material of the filter walls 2 close to the closed regions can be reduced. This likewise reduces the wall flow resistance in relation to the region close to the inflow opening, which produces the above-mentioned positive effect on the flow. In addition to being suitable for use with ceramic honeycomb filters, the apparatus according to the present invention and the method according to the present invention for applying coatings or removing wall material can also be used in sintered metal filters, oxidizing converters, or NOx reservoir catalytic converters. Another alternative embodiment form involves neither the application of a coating nor the removal of wall material. The filter walls contained pores whose areal density, volumetric density, or average size in the upstream filter regions can be reduced slightly in a controlled manner through the introduction of additional material. The material here must be able to withstand the operating conditions of the filter and should therefore be comprised of a suitable ceramic or precursor material that is then fixed by means of tempering or firing. Another possibility lies in precipitating particles comprised of ceramic or precursor material out of the gas phase onto the surface of the particle filter so that they are deposited preferably in the upstream region of the filter. This coating is then affixed to the substrate by means of a corresponding tempering or firing process.

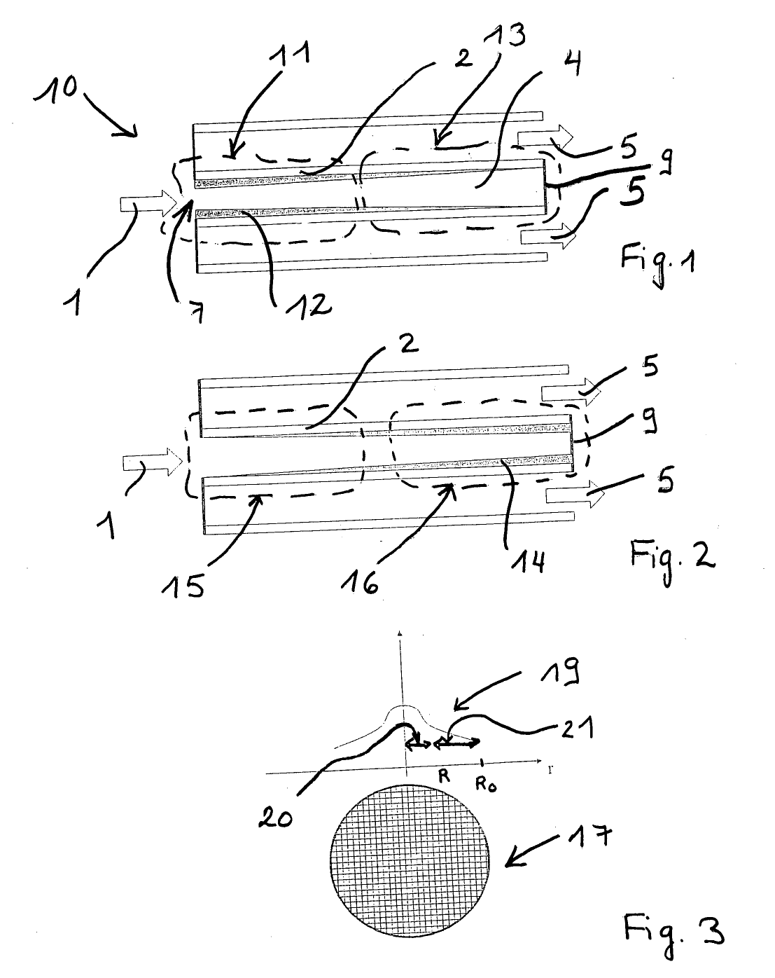

FIG. 2 shows a partial region of an alternative honeycomb filter made of ceramic in which a coating 14 applied to the filter walls 2 has a thickness that increases in the flow direction of the exhaust. Analogous to the apparatus 2 shown in FIG. 1, this produces regions 15 and 16 with different flow resistances; in the current instance, the flow resistance for the exhaust increases toward the closed region 9.

The goal of this form of the gradient coating is to prevent soot from collecting in the downstream region of the filter. Because of the lower flow resistance at the entry to the filter, a large part of the flow occurs in this region so that the maximum amount of soot is deposited here. In the upstream region of the filter, the regeneration is not problematic, however, due to the use of the CRT effect (“CRT”=“continuously regenerating trap”). The soot in the upstream filter region is frequently oxidized by means of nitrogen dioxide and is the first to combust in a thermal oxidation, thus assuring the convective removal of reaction heat along with a favorable flow.

FIG. 3 schematically depicts the cross section 17 of a ceramic honeycomb filter.

Above the cross section 17, there is a graph of the flow resistance 19 as a function of the radius r. The structure of the filter walls 2 (see FIGS. 1 and 2) is chosen so as to produce the radial distribution of the flow resistance depicted in the graph in the individual filter chambers disposed parallel to one another. The cylindrically embodied filter body here has a radius R0. The flow resistance is the greatest at the center of the filter body and decreases toward the edge. There are two discernible regions 20 and 21 with different flow resistances. The first region 20 is situated at the center of the filter body and extends from the symmetry axis of the cylindrical filter body to a radius R. The second region 21 extends from the radius R to the outer edge of the filter body. A corresponding embodiment of the filter walls increases the flow resistance in the region 20 in comparison to the flow resistance in the region 21.

The variation of the flow resistance in the radial direction is intended to encourage a uniform flow through the filter. In filters, the problem frequently arises that the flow passes through only the center region of the filter. In diesel particle filters, this can result in greater quantities of soot being deposited in the outer region of the filter, which can lead to an increased thermal load during a regeneration process if a favorable flow does not pass through this region. An increased flow resistance in the center region of the filter, i.e. in the region 20, shifts the flow more into the outer regions of the filter. In addition, a radial gradient in the flow resistance in the individual filter channels, i.e. a differently embodied permeability of different flow channels, can achieve an improvement in the flow through the filter.

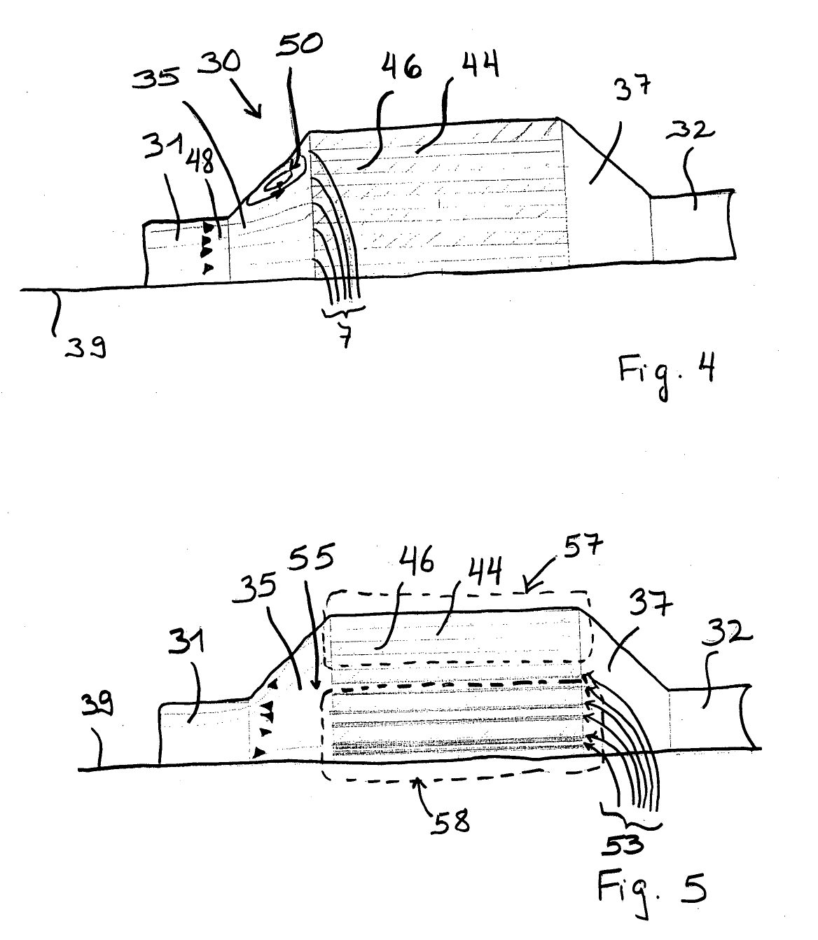

The production of a higher flow resistance in the center of a filter or catalytic converter is not limited to a diesel particle filter but can also be used in oxidizing converters or, for example, NOx reservoir catalytic converters to improve flow distribution over the cross section and to improve utilization of the catalytic converter volume. This will be explained in greater detail in conjunction with FIGS. 4 and 5.

FIG. 4 shows a cross-sectional side view of a reservoir catalytic converter 30; for the sake of simplicity, only half of the reservoir catalytic converter on one side of the symmetry line 39 is shown. An exhaust line 31 leads via a diffuser 35 to a region of the reservoir catalytic converter with parallel flow regions embodied in the form of flow channels 44, which, starting from inflow openings 7 oriented toward the diffuser, extend to the mixer 37 that is connected to their downstream ends and feeds into a continuing exhaust line 32. The flow channels can, for example, have square, circular, or even annular cross-sectional areas perpendicular to the exhaust flow; in the latter instance, the schematic depiction is to be interpreted such that for each flow channel, only half of the side cross section is depicted. The flow channels 44 are delimited by delimiting devices embodied in the form of catalytically coated channel walls 46, which, by contrast with the structures shown in FIGS. 1 through 3, are embodied to be impermeable to the exhaust. The lines labeled with the reference numeral 48 represent flow lines of a flowing exhaust and the reference numeral 50 indicates vortex lines.

The cross-sectional areas of the flow channels perpendicular to the main flow direction of the exhaust from the exhaust line 31 to the exhaust line 32 have the same size in the inner region of the catalytic converter as in the edge region of the catalytic converter. Due to the widening of the flow chamber in the region of the diffuser, however, exhaust vortices 50 form in the edge region and the flow through the flow channels on the inside of the catalytic converter is more powerful than the flow through the flow channels downstream of the vortex lines 50 in the edge region of the catalytic converter.

FIG. 5 shows a catalytic converter apparatus that is modified in relation to the apparatus according to FIG. 4. Components which are the same or similar have been provided with the same reference numerals as in FIG. 4 and are not described again. The channel walls 46 are covered with coatings 53 whose thicknesses decrease from the inside of the catalytic converter close to the symmetry line 39 out toward the edge region. The material of the coatings is the same as the material of the channel walls, but in lieu of being applied to the channel walls 46, a catalytically active coating is provided on the coatings 53 that have been applied to the channel walls. The flow lines 55 symbolize the flow path of the exhaust. In the edge region of the catalytic converter, dashed lines depict a first region 57 of low flow resistance and in the inner region of the catalytic converter, dashed lines depict a second region 58 of high flow resistance. The coating was produced by means of a masking technique in which in particular, the edge regions of a catalytic converter base body had been coated at the ends before the coatings were applied in an immersion bath. In the simplest case, some channel walls inside the catalytic converter are coated while the channel walls in the edge regions of the catalytic converter remain uncoated. The coating is comprised of a washcoat covering.

Thicker coatings 53 in the center region of the catalytic converter than in the edge region of the catalytic converter and/or the mere presence of coatings 53 in the center region of the catalytic converter (in comparison to uncoated regions in the edge region) increases the flow resistance in the center of the catalytic converter in comparison to the edge region so that in comparison to the apparatus according to FIG. 4, a more uniform flow through all of the flow channels is assured (the flow resistance in the region 58 is higher than in the region 57). Thanks to the flow resistance that decreases from the center out toward the edge, the flow of the exhaust in the edge region in comparison to the center is specifically encouraged so as to compensate for the different exhaust flow through the channels that occurs when there is no coating 53.

The catalytic converter can alternatively also be embodied as a three-way catalytic converter, an oxidizing converter, or a catalytic converter for selective catalytic reduction. In one embodiment variant, the catalytic converter base body can also be prefabricated so that the flow channels in the inner region of the body have a greater flow resistance than in the edge region. The body then need only be uniformly coated with a catalytically active substance in the event that the base body itself does not already contain catalytically active materials. In another alternative embodiment form, the coatings 53 themselves can also contain the catalytically active material. In addition to washcoat coverings, it is also suitable to use any other possible coating method that can provide a uniform application of material in the flow channels. In an alternative embodiment form, the catalytic converter 30 can also be asymmetrically embodied, i.e. it does not need to have a symmetry line 30.

1-17. (canceled)

18. An exhaust treatment apparatus comprising
a flow permeable body through which the exhaust of an internal combustion engine can flow, the body having flow regions with different flow resistances, including flow regions (4, 44) that are separate from one another and are each delimited by a delimiting device (2, 12, 14, 46), each flow region having at least one inflow opening (7) that the exhaust is able to act on and the different flow resistances in the regions (11, 13; 15, 16; 20, 21; 57, 58) being produced by differently embodied delimiting devices.

19. The exhaust treatment apparatus according to claim 18, wherein the delimiting devices are permeable to the exhaust and can retain soot particles contained in the exhaust.

20. The exhaust treatment apparatus according to claim 19, wherein the permeability of the delimiting devices varies.

21. The exhaust treatment apparatus according to claim 20, wherein the different permeabilities of the delimiting devices are at least partially determined by correspondingly selected thicknesses of the delimiting devices.

22. The exhaust treatment apparatus according to claim 18, wherein the delimiting devices each comprise a wall and a coating (12, 14, 53) whose thickness varies at least partially covering this wall.

23. The exhaust treatment apparatus according to claim 20, wherein the permeability of at least one delimiting device in a region (11; 15) of the delimiting device oriented toward the inflow opening differs from the permeability of the delimiting device in a region (13; 16) oriented away from the inflow opening.

24. The exhaust treatment apparatus according to claim 21, wherein the permeability of at least one delimiting device in a region (11; 15) of the delimiting device oriented toward the inflow opening differs from the permeability of the delimiting device in a region (13; 16) oriented away from the inflow opening.

25. The exhaust treatment apparatus according to claim 20, wherein the permeabilities of at least two delimiting devices differ from each other.

26. The exhaust treatment apparatus according to claim 23, wherein the permeabilities of at least two delimiting devices differ from each other.

27. The exhaust treatment apparatus according to claim 19, wherein the delimiting devices are at least partially comprised of porous material and the different permeabilities of the delimiting devices are at least partially determined by correspondingly selected pore densities and/or pore sizes in the regions.

28. The exhaust treatment apparatus according to claim 25, wherein the delimiting devices are at least partially comprised of porous material and the different permeabilities of the delimiting devices are at least partially determined by correspondingly selected pore densities and/or pore sizes in the regions.

29. The exhaust treatment apparatus according to claim 25, wherein the permeabilities of at least two delimiting devices in regions close to the inflow openings and/or in regions remote from the inflow openings differ from each other.

30. The exhaust treatment apparatus according to claim 18, wherein the flow regions have cross-sectional areas perpendicular to the flow direction of the exhaust and the delimiting devices are embodied differently so that the geometric areas of the cross-sectional areas in the regions differ from one another.

31. The exhaust treatment apparatus according to claim 18, further comprising a continuous transition between the regions of different flow resistances.

32. The exhaust treatment apparatus according to claim 18, wherein the flow-permeable body constitutes an oxidizing converter or a reservoir catalytic converter (30) for NOx-reduction of the exhaust.

33. The exhaust treatment apparatus according to claim 18, wherein the flow-permeable body constitutes a particle filter.

34. The exhaust treatment apparatus according to claim 18, wherein the delimiting devices are comprised of ceramic walls.

35. The exhaust treatment apparatus according to claim 18, wherein the delimiting devices are comprised of metal meshes.

36. The exhaust treatment apparatus according to claim 34, wherein the filter is a sintered metal filter.

37. The exhaust treatment apparatus according to claim 18, wherein the flow regions are disposed parallel to one another so that their inflow openings are situated on one side of the body.
